(19) United States
(12) Patent Application Publication
(10) Pub. No.: US 2025/0185690 A1
(43) Pub. Date: Jun. 12, 2025

(54) MEAT-ANALOGUE COMPOSITION

(71) Applicant: AAK AB (PUBL), Malmö (SE)

(72) Inventors: Andrea WEIS, Malmo (SE); Niall SANDS, Malmo (SE); Lucas HARDY, Malmo (SE); Paulo PEDRO, Malmo (SE); Carol KONG, Malmo (SE); Amelia CHOO, Malmo (SE)

(21) Appl. No.: 18/843,485

(22) PCT Filed: Mar. 6, 2023
(86) PCT No.: PCT/SE2023/050203

§ 371 Date: Sep. 3, 2024

(30) Foreign Application Priority Data
Mar. 7, 2022 (SE) 2230064-4
Oct. 25, 2022 (SE) 2230344-0

(51) Int. Cl. A23J 3/22; A23D 9/007; A23D 9/05; A23J 3/14; A23L 29/206

(52) U.S. Cl. CPC A23J 3/227; A23D 9/007; A23D 9/05; A23J 3/14; A23L 29/206

(57) ABSTRACT

The present invention relates to meat analogue compositions comprising a fat composition, wherein the fat composition in solid form comprises a vegetable fat and insoluble non-animal fibers; and the use of said meat analogue compositions in food products. In particular, the invention relates to the use of certain fat compositions in meat analogue compositions to improve various properties of the meat analogue compositions.

### FIELD OF THE INVENTION

The invention relates to meat analogue compositions comprising a fat composition, and the use of said meat analogue compositions in food products. In particular, the invention relates to the use of certain fat compositions in meat analogue compositions to improve various properties of the meat analogue compositions.

### BACKGROUND OF THE INVENTION

There is an increasing demand for plant-based foods due to consumer's increasing desire to eat healthy, sustainably sourced food products and to generally lower their meat intake. This has led to the development of meat-analogues; meat-free, vegetarian or vegan food products which mimic certain qualities of meat or meat-based products, such as the texture, taste and/or appearance.

Many different types of meat-analogues are available, such as those based on tofu, lentils and beans, some of which aim to mimic meat completely in terms of sizzling and browning during cooking, bleeding, colour, texture and taste. One example of such meat-analogues is plant-based burgers. Products such as plant-based sausages, meat balls, meat loaf and nuggets are also known in the art.

The typical composition of known meat-analogues is 50 to 60% water, 10 to 25% proteins (such as soy, pea, potato and wheat), 5 to 20% fat, 0 to 10% carbohydrates, as well as flavourings and colourings. Various fats have been proposed for use in meat analogue compositions. It is important that the fat is not an animal-derived fat such that the meat analogue composition is suitable for consumption by vegetarians and vegans. Accordingly, animal fats that are typically solid at room temperature are generally not used in meat analogue compositions.

In order to produce a desirable meat-analogue, it is important that the final product have an appealing taste, texture and mouthfeel, and have similar taste, texture and mouthfeel to meat. Such properties are generally affected by the nature of the fat included in the meat analogue composition. The nature of the fat in meat analogue compositions also typically has an effect upon juiciness of the compositions and upon flavour release as the fats often function as carriers for fat soluble flavours. The nature of the fat is also important for providing visual similarity to meat products. In particular, the nature of the fat is also important providing a visual marbling aspect for products such as plant-based sausages, plant-based pepperonis and meat balls.

Coconut oil, palm oil, sunflower oil and rapeseed oil are examples of vegetable derived fats that have been proposed for use in meat analogue compositions. It is desirable that the fats have a relatively high melting point in order to mimic effects such as the taste, texture and mouthfeel of high melting point animal fats found in meats which are typically solid at room temperature. As a result, coconut oil and palm oil have attracted attention as they have relatively high melting points compared to other vegetable oils. Of these oils, coconut oil is typically preferred due to the negative environmental effects associated with the production of palm oil. Furthermore, palm oil contains a high amount of palmitic acid residues which is considered to be detrimental to cholesterol levels of consumers.

Additionally, there are various disadvantages of using palm oil and coconut oil in meat analogue compositions. As discussed above, coconut oil is high in saturated fatty acid residues which is undesirable for consumers from a health perspective due to the association of saturated fatty acid residues in fats with heart disease, undesirable cholesterol levels, and related conditions. The inventors of the present invention have also appreciated that coconut oil, despite having a relatively high melting point for a vegetable oil, has a steep melting curve. In other words at colder temperatures of less than 15° C., coconut oil is a hard brittle solid, whereas at higher temperatures of 30° C. to 35° C., the coconut oil is a liquid containing no or very little solid fat. It has been found by the inventors that properties such as visual marbling aspect are compromised and the liquid nature of the oils create problems during processing of the meat analogue compositions even though coconut oil remains the industry standard for the fat used in meat analogue compositions. The inventors have appreciated that during the processing, i.e. the manufacture, of the meat analogue compositions that often includes a heat treatment, coconut oil and palm oil melt into the meat analogue compositions. Furthermore, the inventors have also appreciated that during the cooking of the meat analogue composition, especially the baking, the same disadvantages occur. Consequently, the resultant composition does not effectively mimic the appearance of animal meat since the melted fat leaves holes in the structure of the meat analogue composition. The appearance does not resemble how animal fat particles are dispersed within animal meat.

The document discussed below relates to the use of the coconut fat and other fat compositions in meat analogue compositions.

WO2021/018632 discloses a formed meat analogue product comprising two intermixed parts having each a color, wherein a first part comprises a textured plant protein, a binder, and optionally a colorant; a second part comprises a vegetable fat and a starch; wherein the color of the second part is different from the color of the first part; and wherein the second part is intermixed with the first part in such a way as to provide a visual aspect of the meat analogue product as a marbled meat analogue product. The vegetable fat in the second part is selected from coconut fat, palm fat, shea butter, and a combination thereof.

This document does not solve the problems discussed above associated with the use of coconut fat and other fats in such compositions. There remains a need for providing a meat analogue composition that solve or alleviate many of the problems discussed above such as to mimic the animal fat present in meat products. In particular, it would be especially convenient to provide a meat analogue composition having an improved visual marbling aspect even after processing the meat analogue composition, including for example a heat treatment and/or a cooking step.

### SUMMARY OF THE INVENTION

According to a first aspect of the invention, there is provided a meat analogue composition comprising a fat composition in solid form, wherein the fat composition comprises a vegetable fat and non-animal insoluble fibers, said vegetable fat and non-animal insoluble fibers being intermixed.

The present invention is based upon the surprising finding that certain fat compositions solve or alleviate many of the problems discussed above associated as to mimic the animal fat present in meat products. It has been found that the certain fat compositions mimic the appearance of animal meat when compared to an analogous meat analogue composition comprising the same amount by weight of coconut fat due to having lower amount of non-animal fibers. Surprisingly, the inclusion of these fat compositions in meat analogue compositions in place of coconut fat has been found to not negatively affect, and in some cases improve various properties of meat analogue compositions such as various sensory and visual properties of the compositions. It has been found that these certain fat compositions with improved nutritional profile provide improved visual marbling aspect to the meat analogue compositions, in particular when processed, i.e. when heat treated, when cooked or partially cooked, in comparisons to meat analogue compositions comprising an equivalent amount of coconut fat. It has also been found that the use of the certain fat compositions in place of coconut fat also has a positive effect on the texture related features, such as sliceability, of the meat analogue composition once cooked.

Without being limited by theory, the inventors have surprisingly found that even though the fat compositions according to the present invention and the coconut fat have the same melting behaviour when analyzed by differential scanning calorimetry (DSC), in practice, the vegetable fat and the non-animal insoluble fibers of the fat composition form a matrix of solid fat having an enhanced thermal stability. Indeed, it is believed that the non-animal insoluble fibers collaborate with the vegetable fat to obtain a specific chemical organization leading to a more stable fat. It is believed that the non-animal insoluble fibers are bound to a portion of the vegetable fat allowing retaining some amount of melt vegetable fat after a heat treatment and/or a cooking step. Thus, even though a low amount of vegetable fat leaches into the meat analogue composition during a heat treatment and/or a cooking step, the non-animal insoluble fibers retain their appearance preventing the visual appearance of holes. Indeed, the use of non-animal insoluble fibers is believed to play an important role in the matrix of solid fat formed by said non-animal insoluble fibers and the vegetable fat which is not the case for non-animal soluble fibers. The inventors have found that using non-animal soluble fibers in the fat composition, in particular mixing the vegetable fat and non-animal soluble fibers of the fat composition, do not provide a stable matrix of solid fat, but rather an unstable matrix having an unstructured organization. Thus, after a heat treatment and/or a cooking step, the vegetable fat and the non-animal soluble fibers dissolve almost completely or even completely leaving visible holes and leading to an absence of marbling effect.

Furthermore, the ability to admix the fat compositions of the present invention into meat analogue compositions has also been found useful by the inventors to provide heterogeneity to the surfaces of food products containing the meat analogue compositions meaning that said food products more closely mimic the visual appearance of meat. In particular, hard brittle structures of the fat compositions can be provided and mixed into the meat analogue compositions which mimic the marble visual aspect in meat compositions. A further advantage of the compositions for use in the invention is that since they have higher thermal stability than coconut fat, where it is desired to include solid fat in the meat analogue compositions, processing can be done at higher temperatures than coconut fat without the solid fat melting. The fat compositions thus improve both the textural and sensory properties of the finished meat analogue composition product.

The term “fat” as used herein refers to glyceride fats and oils containing fatty acid acyl groups and does not imply any particular melting point. The term “oil” is used synonymously with “fat” herein.

The term “animal meat’ herein refers to a meat originated from animal.

The term “fat composition in solid form” means that the fat composition holds its structure at 20° C. In other words, the vegetable fat and the non-animal insoluble fibers of the fat composition form a matrix of solid fat. Preferably, the fat composition in solid form has a solid fat content of equal to or more than 29% at 20° C. as determined by ISO 8292-1. The verb “to solidify” or is used synonymously with the verb “to crystallize” herein.

The term “non-animal insoluble fibers” refers to a type of carbohydrates that are substantially not soluble in water, i.e. that are substantially not digestible by a human body. Preferably, the term “non-animal insoluble fibers” refers to a type of carbohydrates that are not soluble in water, i.e. that are not digestible by a human body. Suitable sources of non-animal insoluble fibers generally comprise at least 45% by weight of insoluble fibers with respect to the total content of dietary fibers. The insoluble fibers content may be measured using gravimetry according to the method AOAC 991.43.

Preferably, suitable sources of non-animal insoluble fibers comprise at least 60% by weight of insoluble fibers with respect to the total content of dietary fibers. More preferably, suitable sources of non-animal insoluble fibers comprise at least 70% by weight of insoluble fibers with respect to the total content of dietary fibers. Advantageously, suitable sources of non-animal insoluble fibers comprise at least 80%, such as at least 85%, such as at least 95%, by weight of insoluble fibers with respect to the total content of dietary fibers.

Preferably, the non-animal insoluble fibers are selected from vegetable fibers, fruit fibers, plant fibers and, and any combination thereof. Preferably, the non-animal insoluble fibers are selected from peas fibers such as yellow or green peas fibers, potato fibers, citrus fibers, bamboo fibers, oat fibers, wheat fibers, cellulose fibers, and any combination thereof. Advantageously, the non-animal insoluble fibers are selected from peas fibers such as yellow or green peas fibers, bamboo fibers, oat fibers, and any combination thereof. Without willing to be bound by any theory, it is believed that the fat compositions comprising such fibers may be particularly useful for providing hard, brittle solid structures of fat that can be easily admixed with other components of the meat analogue composition so as to provide a marble visual aspect to the meat analogue composition or a food product containing the meat analogue composition.

Preferably, the non-animal insoluble fibers comprise less than 30% by weight of protein; preferably less than 20% by weight of protein; more preferably less than 15% by weight of protein; advantageously less than 10% by weight of protein or less than 5% by weight of protein. Alternatively, non-animal insoluble fibers are free of proteins. Without willing to be bound by any theory, it is believed that having a content of protein outside this range may negatively impact the structure of the solid matrix of the fat composition and therefore, decrease the marble visual aspect.

Preferably, only the vegetable fat and non-animal insoluble fibers are intermixed together. The inventors have found that mixing the vegetable fat and the non-animal insoluble fibers together before adding them into the meat analogue composition enhances the structure of the fat composition to obtain a specific chemical organization leading to a more stable fat.

Preferably, the fat composition comprises from 5 to 35% by weight of non-animal insoluble fibers and from 65 to 95% by weight of the vegetable fat. Advantageously, the fat composition comprises from 5 to 25% by weight of non-animal insoluble fibers and from 75 to 95% by weight of the vegetable fat. Alternatively, the fat composition comprises from 10 to 30% by weight of non-animal insoluble fibers and from 70 to 90% by weight of the vegetable fat. It has been found that within these ranges, a portion of the vegetable fat of the fat composition leaches into the meat analogue composition during the heat treatment and/or a cooking step. The inventors have found that it tenderizes the meat analogue composition and softens the bite.

Preferably, the vegetable fat is selected from palm fat, coconut fat, rapeseed fat, high oleic rapeseed fat, high erucic acid rapeseed fat, soybean fat, sunflower fat, high oleic sunflower fat, linseed fat, olive fat, corn fat, cottonseed fat, carinata fat, groundnut fat, safflower fat, shea butter, cocoa butter, allanblackia fat, kokum fat, mango kernel fat, sal fat, illipe butter, palm kernel olein, babassu fat, high oleic safflower fat, peanut fat, avocado fat, rice fat, camelina fat, any fractions thereof and any combination thereof.

In other embodiments, the vegetable fat comprises an interesterified fat, and more preferably the vegetable fat comprises an interesterified fat blend. The interesterified fat or interesterified fat blend may be produced by chemical interesterification, enzymatic interesterification, or a combination thereof.

Processes for the preparation of vegetable fats such as the interesterification reactions discussed above are known in the art, and are discussed in, for example, Dijkstra, A. J. Interesterification. In: The Lipids Handbook 3rd Edition, pages 285-300 (F. D. Gunstone, J. L. Harwood, and A. J. Dijkstra (eds.), Taylor & Francis Group LLC, Boca Raton, FL) (2007).

In some embodiments, the vegetable fat comprises an interesterified blend of shea butter and coconut fat or an interesterified blend of shea stearin and coconut fat. For example, in some embodiments, the vegetable fat comprises an interesterified blend of from 20% to 80% by weight of shea butter and from 20% to 80% by weight of coconut fat. In other embodiments, the vegetable fat comprises an interesterified blend of from 20% to 80% by weight of shea stearin and from 20% to 80% by weight of coconut fat. It has been found that these fat compositions have an improved nutritional profile relative to fats, such as coconut fat, due to having lower amounts of saturated fatty acid residues. Surprisingly, these vegetable fats improve various properties of meat analogue compositions such as various sensory properties of the compositions, such as juiciness, when cooked or partially cooked, in comparison to meat analogue compositions made using liquid oils. The fat compositions thus improve both the nutritional value when compared to fats, such as coconut fat, and sensory properties of the finished plant-based meat analogue products when compared to liquid oils such as rapeseed oil.

Preferably, the vegetable fat comprises a fully hydrogenated fat, preferably the vegetable fat comprises a fully hydrogenated blend. The fully hydrogenated fat or blend may be produced by hydrogenation. Without willing to be bound by any theory, it is believed that fully hydrogenated fats further increase the thermal stability of the fat compositions. Indeed, it is believed that the chemical organization of the solid matrix formed by the vegetable fat and the non-animal insoluble fibers of the fat composition is highly stable. It seems that the non-animal insoluble fibers are bound to a bigger portion of the vegetable fat allowing retaining a higher amount of melt vegetable fat after a heat treatment and/or a cooking step when compared to a fat composition not comprising a fully hydrogenated fat or blend.

The term “fully hydrogenated vegetable fat” as used herein is used to refer to a vegetable fat that has undergone hydrogenation so as to convert its unsaturated fatty acid residues into saturated fatty acid residues. Suitable process conditions and methods for hydrogenating vegetable fat are known in the art. Any suitable fat hydrogenation process known in the art can be used to produce the fully hydrogenated vegetable fats of the present invention. For example, hydrogenation processes discussed in EP2196094 can be used. The term fully hydrogenated as used herein is used to distinguish the hydrogenated vegetable fats for use in producing the hardstock from partially hydrogenated vegetable fats which typically contain a significant quantity of trans fatty acid residues. In full hydrogenation, the hydrogenation process is allowed to continue to such an extent that all or substantially all of the unsaturated fatty acid residues present in the molecule are converted to saturated fatty acid residues. Accordingly, in some embodiments, the fully hydrogenated vegetable fat comprises less than 5% by weight of trans fatty acids, more preferably less than 2% by weight of trans fatty acids and most preferably less than 1% by weight of trans fatty acids, wherein said percentages of fatty acid residues refers to fatty acids bound as acyl groups in glycerides in the fully hydrogenated vegetable fat and being based on the total weight of C4 to C24 fatty acid residues bound as acyl groups present in the fully hydrogenated vegetable fat.

In preferable embodiments, the vegetable fat comprises a hydrogenated blend of soybean fat and coconut fat. Advantageously, the vegetable fat comprises a hydrogenated blend of from 1% to 30% by weight of soybean fat and from 70% to 99% by weight of coconut fat; preferably, the vegetable fat comprises a hydrogenated blend of from 1% to 20% by weight of soybean fat and from 80% to 99% by weight of coconut fat; more preferably, the vegetable fat comprises a hydrogenated blend of from 3% to 10% by weight of soybean fat and from 90% to 97% by weight of coconut fat; and advantageously, the vegetable fat comprises a hydrogenated blend of from 5% to 10% by weight of soybean fat and from 90% to 95% by weight of coconut fat.

Preferably, the hydrogenated blend of soybean fat and coconut fat is produced by hydrogenating a blend including both fats. Alternatively, the soybean fat and the coconut fat are independently form each other hydrogenated before being mixed together so as to obtain the blend.

In preferable embodiments, the vegetable fat comprises a hydrogenated blend of rapeseed fat and coconut fat. Advantageously, the vegetable fat comprises a hydrogenated blend of from 1% to 30% by weight of fat and from 70% to 99% by weight of coconut fat; preferably, the vegetable fat comprises a hydrogenated blend of from 1% to 20% by weight of rapeseed fat and from 80% to 99% by weight of coconut fat; more preferably, the vegetable fat comprises a hydrogenated blend of from 3% to 10% by weight of rapeseed fat and from 90% to 97% by weight of coconut fat; and advantageously, the vegetable fat comprises a hydrogenated blend of from 5% to 10% by weight of rapeseed fat and from 90% to 95% by weight of coconut fat. In this embodiment, it is believed that the vegetable fat is non-allergen such that sensitive people having allergies, notably to soybean fat, may healthily use it.

Preferably, the hydrogenated blend of rapeseed fat and coconut fat is produced by hydrogenated a blend including both fats. Alternatively, the rapeseed fat and the coconut fat are independently form each other hydrogenated before being mixed together so as to obtain the blend.

In preferable embodiments, the vegetable fat comprises a hydrogenated blend of sunflower fat and coconut fat. Advantageously, the vegetable fat comprises a hydrogenated blend of from 1% to 30% by weight of fat and from 70% to 99% by weight of coconut fat; preferably, the vegetable fat comprises a hydrogenated blend of from 1% to 20% by weight of sunflower fat and from 80% to 99% by weight of coconut fat; more preferably, the vegetable fat comprises a hydrogenated blend of from 3% to 10% by weight of sunflower fat and from 90% to 97% by weight of coconut fat; and advantageously, the vegetable fat comprises a hydrogenated blend of from 5% to 10% by weight of sunflower fat and from 90% to 95% by weight of coconut fat. In this embodiment, it is believed that the vegetable fat is non-allergen such that sensitive people having allergies, notably to soybean fat, may healthily use it.

Preferably, the hydrogenated blend of sunflower fat and coconut fat is produced by hydrogenating a blend including both fats. Alternatively, the sunflower fat and the coconut fat are independently form each other hydrogenated before being mixed together so as to obtain the blend.

Preferably, the fat composition is in the form of discrete fat pieces in the meat analogue composition. Preferably, the fat composition is in the form of granulates and/or flakes. Without willing to be bound be any theory, it is believed that the granulates and/or flakes form of the fat compositions provides an appropriate shape to mimic the naturally occurring animal solid fat in meat.

Typically, the granulates have a particle size distribution between 1 mm and 7 mm and preferably between 2 mm and 6 mm. The flakes may have a thickness between 0.2 mm and 1.5 mm and preferably between 0.3 mm and 0.9 mm or between 0.9 mm and 1.3 mm. The flakes may have a diameter between 1 and 52 mm. It is believed that granulates and/or flakes in these specific above range further improve the visual appearance of the meat analogue composition.

The thickness of flakes can be measured by known methods, e.g. using a micrometer, and the diameter of the flakes can be measured by known methods, e.g. using a measure ruler.

Reference herein to “thickness” when applied to non-circular (e.g. irregular shaped) flake corresponds to the smallest dimension of the individual flake.

As would be appreciated, the particle size distribution refers to the diameter of granulates present in an amount of at least 80% by weight, preferably at least 85% by weight, and for example of 96% by weight, with respect to the total amount of granulates, i.e. of 100% by weight, in a sample to be measured. The distribution of diameters of the granulate described herein can be measured by known methods, including sieve tests such as, ASTM E11, which is a woven wire sieve test.

Reference herein to “diameter” when applied to non-circular (e.g. irregular shaped) granulate or flake corresponds to the largest dimension of the individual granule or flake. When a granulate diameter is measured using a sieve test, such as ASTM E11, the largest dimension may be considered to be the largest sieve size (i.e. wire opening diameter) at which granulate is retained on the sieve. In one embodiment, the granulates have a particle size distribution of: 13 wt. %, 1 to 2.36 mm diameter; 45 wt. %, 2.36 to 3.35 mm diameter; and 38 wt. %, 3.35 to 6.7 mm diameter, as measured in accordance with ASTM E11. As would be appreciated, this particle size distribution, for example, can be identified by measuring the total weight of the granulate, and then sequentially measuring the weight that passes through the appropriate sieve size, in accordance with ASTM E11.

Typically, the fat composition has one or more of the following properties:
a marble visual aspect after a heat treatment at a temperature of at least 60° C.,
a marble visual aspect after a heat treatment at a temperature less than 90° C.,
a marble visual aspect after a heat treatment at a temperature between 8° and 90° C.,
a marble visual aspect after a cooking step at a temperature of at least 180° C.,
a marble visual aspect after a cooking step at a temperature less than 250° C.,
a marble visual aspect after a cooking step at a temperature between 20° and 250° C.

Without willing to be bound by any theory, it is believed that the fat composition prevents the formation of holes. Furthermore, the fat composition maintains its shape, texture and marble visual aspect even after processing the meat analogue composition, including for example a heat treatment and/or a cooking step.

Typically, the heat treatment is a steam treatment. Preferably, the time period of the heat treatment is from 10 to 30 minutes.

Typically, the cooking step comprises a baking step, a grilling step, a boiling step, a frying step and/or a microwaving step. Preferably, the time period of the cooking step is from 5 to 40 minutes.

The meat analogue composition may comprise a non-animal protein and water. The non-animal protein may comprise protein derived from fungi, plants, or a combination thereof.

Typically, the non-animal protein comprises plant protein, preferably, wherein the plant protein is selected from algae protein, black bean protein, canola wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof. In other embodiments, the non-animal protein comprises seitan, rice protein, mushroom protein, legume protein, tempeh, yam flour, tofu, mycoprotein, peanut flour, yuba, and a combination thereof.

The non-animal protein may comprise texturized vegetable proteins, preferably wherein the texturized vegetable proteins comprise texturized pea proteins, texturized fava proteins, or a combination thereof. Preferably, the non-animal protein is present in the meat analogue composition in an amount of from 5 to 30% by weight, preferably from 10 to 30% by weight, and advantageously from 15 to 25% by weight, of the meat analogue composition.

The meat-analogue composition may comprise water, which may be added as a separate component to the composition, or derive from other components of the composition as discussed above. Typically, water is present in the meat analogue composition in an amount of from 20 to 70% by weight, preferably from 20 to 50% by weight and advantageously from 30 to 45% by weight of the meat analogue composition. Reference to ‘water’ herein is intended to include drinking water, demineralized water or distilled water, unless specifically indicated. Preferably, the water employed in connection with the present invention is demineralised or distilled water. As the skilled person will appreciate, deionized water is also a sub-class of demineralized water.

The meat analogue composition may comprise one or more flavouring additives. Preferably, the one or more flavouring additives are present in an amount of from 0.5% to 5% by weight of the meat analogue composition. Suitable flavouring additives known in the art may be used in the meat analogue compositions.

The meat analogue composition may comprise one or more colouring additives. Typically, the one or more colouring additives are present in an amount of from 0.5% to 5% by weight of the meat analogue composition. Suitable colouring additives known in the art may be used in the meat analogue compositions.

In some embodiments, the meat analogue composition further comprises one or more of:
i). polysaccharides and/or modified polysaccharides, preferably selected from methylcellulose, hydroxypropyl methylcellulose, carboxymethyl cellulose, maltodextrin, carrageenan and salts thereof, alginic acid and salts thereof, agar, agarose, agaropectin, pectin and alginate;
ii). hydrocolloids; and
iii). gums, preferably selected from xanthan gum, guar gum, locust bean gum, gellan gum, gum arabic, vegetable gum, tara gum, tragacanth gum, konjac gum, fenugreek gum, and gum karaya.

Examples of other additives that may be included in the meat analogue compositions comprise an ionic or non-ionic emulsifier, a polyhydroxy compound, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, starch, salt, spices, fibre, flavour components, colourants, thickening and gelling agents, egg powder, enzymes, gluten, vitamins, preservatives, sweeteners, oxidising agents, reducing agents, anti-oxidants, and acidity regulators.

Preferably, the fat composition is present in the meat analogue composition in an amount of from 5% to 40% by weight and advantageously from 10% to 25% by weight of the meat analogue composition.

In preferable embodiments, the meat analogue composition is free of palm and palm kernel oils.

Advantageously, the meat analogue composition is free of hydrogenated oils.

Preferably, the meat analogue composition is substantially free of animal protein and/or animal fats, and more preferably, free of animal protein and/or animal fats.

In preferable embodiments, the meat analogue composition is substantially free of animal-derived products, and more preferably, free of animal-derived products.

Preferably, the meat analogue composition is substantially free of emulsions; more preferably, wherein the meat analogue composition is free of emulsions.

Preferably, the meat analogue composition is not in a form of an emulsion.

According to a second aspect of the invention, there is provided a food product comprising a meat analogue composition of the invention. The food product may be an uncooked food product, a cooked food product, or a partially cooked food product.

Typically, the food product is a vegetarian or vegan meat substitute food product.

Preferably, the vegetarian or vegan meat substitute food product is a cut of meat, fish meat, burger, sausage, pepperoni, meat ball, nugget, patty, mince product, meatloaf, or other product intended to mimic conventional meat-based food products. The term “cut of meat” means any piece of meat that has not been processed, e.g. a piece of chicken or a piece of beef. Advantageously, the vegetarian or vegan meat substitute food product is a pepperoni.

According to a third aspect of the invention, there is provided the use of a fat composition in a meat analogue composition, wherein the fat composition in solid form comprises a vegetable fat and non-animal insoluble fibers, said vegetable fat and non-animal insoluble fibers being intermixed.

Preferably, the use of a fat composition in a meat analogue composition, wherein the fat composition comprises from 5 to 35% by weight of non-animal insoluble fibers and from 65 to 95% by weight of vegetable fat.

Preferably, the use further comprises using the meat analogue composition in a food product.

Preferably, the meat analogue composition, fat composition and/or food product are as described above.

The use may comprise using the fat composition to improve the visual marble aspect of the meat analogue composition after a heat treatment at a temperature of at least 60° C. when compared to an analogous meat analogue composition comprising the same amount by weight of coconut fat.

The use may comprise using the fat composition to improve the visual marble aspect of the meat analogue composition after a heat treatment at a temperature less than 90° C. when compared to an analogous meat analogue composition comprising the same amount by weight of coconut fat.

The use may comprise using the fat composition to improve the visual marble aspect of the meat analogue composition after a heat treatment at a temperature between 8° and 90° C. when compared to an analogous meat analogue composition comprising the same amount by weight of coconut fat.

The use may comprise using the fat composition to improve the visual marble aspect of the meat analogue composition after a cooking step at a temperature of at least 180° C. when compared to an analogous meat analogue composition comprising the same amount by weight of coconut fat.

The use may comprise using the fat composition to improve the visual marble aspect of the meat analogue composition after a cooking step at a temperature less than 250° C. when compared to an analogous meat analogue composition comprising the same amount by weight of coconut fat.

The use may comprise using the fat composition to improve the visual marble aspect of the meat analogue composition after a cooking step at a temperature between 20° and 240° C. when compared to an analogous meat analogue composition comprising the same amount by weight of coconut fat.

Animal meat tends to have a more heterogeneous structure, with visible solid fat structures (marbling) present on the surfaces of the meat product. The fat compositions described herein can be effectively mixed with the other ingredients of the meat analogue composition heat treated during manufacture and cooked without any risk to lose the visual marble aspect. This results in a substantially uniform dispersion of the fat composition in the meat analogue compositions, but with larger, solid, visible fat granulates and/or flakes. The surfaces of food products made from the meat analogue compositions thus more closely resemble the visual appearance of animal meat, and have increased heterogeneity compared to meat analogue compositions containing melted fats.

The use may comprise using the fat composition to maintain the texture related features, such as sliceability, of the meat analogue composition after a heat treatment at a temperature of at least 60° C. when compared to an analogous meat analogue composition comprising the same amount by weight of coconut fat.

The use may comprise using the fat composition to improve the texture related features, such as sliceability, of the meat analogue composition after a heat treatment at a temperature less than 90° C. when compared to an analogous meat analogue composition comprising the same amount by weight of coconut fat.

The use may comprise using the fat composition to improve the texture related features, such as sliceability, of the meat analogue composition after a heat treatment at a temperature between 8° and 90° C. when compared to an analogous meat analogue composition comprising the same amount by weight of coconut fat.

The use may comprise using the fat composition to improve the texture related features, such as sliceability, of the meat analogue composition after a cooking step at a temperature of at least 180° C. when compared to an analogous meat analogue composition comprising the same amount by weight of coconut fat.

The use may comprise using the fat composition to improve the texture related features, such as sliceability, of the meat analogue composition after a cooking step at a temperature less than 250° C. when compared to an analogous meat analogue composition comprising the same amount by weight of coconut fat.

The use may comprise using the fat composition to improve to improve the texture related features, such as sliceability, after a cooking step at a temperature between 20° and 240° C. when compared to an analogous meat analogue composition comprising the same amount by weight of coconut fat.

The fat compositions of the present invention maintain their texture related features, such and sliceability, and the taste mimicking a meat-based product.

The use may comprise using the fat composition to reduce the holes formation in the meat analogue composition after a heat treatment at a temperature of at least 60° C. when compared to an analogous meat analogue composition comprising the same amount by weight of coconut fat.

The use may comprise using the fat composition to reduce the holes formation of the meat analogue composition after a heat treatment at a temperature less than 90° C. when compared to an analogous meat analogue composition comprising the same amount by weight of coconut fat.

The use may comprise using the fat composition to reduce the holes formation of the meat analogue composition after a heat treatment at a temperature between 8° and 90° C. when compared to an analogous meat analogue composition comprising the same amount by weight of coconut fat.

The use may comprise using the fat composition to reduce the holes formation of the meat analogue composition after a cooking step at a temperature of at least 180° C. when compared to an analogous meat analogue composition comprising the same amount by weight of coconut fat.

The use may comprise using the fat composition to reduce the holes formation of the meat analogue composition after a cooking step at a temperature less than 250° C. when compared to an analogous meat analogue composition comprising the same amount by weight of coconut fat.

The use may comprise using the fat composition to reduce the holes formation of the meat analogue composition after a cooking step at a temperature between 20° and 240° C. when compared to an analogous meat analogue composition comprising the same amount by weight of coconut fat.

Without willing to be bound by any theory, it is believed that not only improved processability and handleability is provided, for example, but also either the fat composition remains in solid form even after processing the meat analogue composition, including especially the heat treatment and/or the cooking or the non-animal insoluble fibers are bound to a portion of the vegetable fat allowing retaining some amount of melt vegetable fat during and after the heat treatment and/or a cooking step, said vegetable fat re-solidifying upon cooling. The fat can be processed and mixed with other components of a meat analogue composition at higher temperatures without melting avoiding the holes formation.

According to a fourth aspect of the invention, there is provided a process of manufacturing a meat analogue composition of the invention or a food product of the invention.

Preferably, there is provided a process of manufacturing a meat analogue composition of the invention, or a food product of the invention, wherein the process comprises:
A). providing a mixture comprising a non-animal protein and water;
B). combining the mixture from step A) with the fat composition in solid form and optionally one or more additional components to form the meat analogue composition; and
C). optionally forming the meat analogue composition into food products.

Preferably, before step B), the fat composition is produced by mixing the vegetable fat and the non-animal fibers. Advantageously, the non-animal insoluble fibers are in powder form. Advantageously, the vegetable fat is molten. Then, the mixture of vegetable fat and non-animal insoluble fibers poured onto an ambient plate, i.e. a plate at ambient temperature, or a cooled plate and cooled until the fat composition solidifies. The fat composition is broken so as to obtain flakes and optionally, the flakes are diced to obtain granulates.

In another embodiment, the fat composition is produced by mixing the vegetable fat and the non-animal insoluble fibers. Advantageously, the non-animal insoluble fibers are in powder form. Advantageously, the vegetable fat is molten. Then, the mixture of vegetable fat and non-animal insoluble fibers is refrigerated to crystallize, for example using a chilled drum, so as to obtain flakes. Then, optionally, at least a part of the flakes is grinded so as to obtain granulates.

Alternatively, the mixture of vegetable fat and non-animal insoluble fibers are extruded and cut so as to form flakes and/or granulates. Preferably, the extrusion is performed using the method described in PCT/SE2023/050168.

Once the meat-analogue composition has been prepared, this may be formed into a food product in step C). This may include the step of forming the meat-analogue composition into the desired shape. The shape and size of the resulting food product is not particularly limited. Examples of shaped food products which can be made from the meat-analogue composition according to the present invention include cut of meat, fish meat, burger, sausage, pepperoni, meat ball, nugget, patty, mince product, meatloaf, or other product intended to mimic conventional meat-based food products.

Any suitable method may be used to shape the meat-analogue composition into the desired shape. In embodiments, this may be performed by cutting, moulding, pressing, extrusion, rolling, grinding or any combination thereof. These processes may be performed using an apparatus, which may be operated manually or may be automated. In embodiments, the meat-analogue composition may be compressed for 5 minutes to 24 hours, preferably 1 hour to 12 hours, more preferably 3 hours to 8 hours. The duration and pressure of compression is determined by the desired properties of the resulting food product, such as its size and density, taking into account the properties of the meat analogue composition, such as adhesiveness, among other factors. This may form the desired shape of the food product, or it may be further processed such as by pelletizing, grinding or cutting, for instance to replicate the attributes of ground/minced meat.

Preferably, in step C), the meat analogue composition is heat treated at a temperature of at least 60° C., preferably at a temperature less than 90° C. and advantageously between 8° and 90° C.

Preferably, in step C), the heat treatment is a steam treatment. Preferably, the time period of the heat treatment is between 10 and 30 minutes.

Preferably, the process further comprises in step C), cooking the food product to form a cooked food product or partially cooked food product. Advantageously, the cooking comprises a baking step, a boiling step, a frying step and/or a microwaving step. Preferably, the time period of the cooking step is between 5 and 40 minutes.

### DESCRIPTION OF THE DRAWINGS

FIGS. 1a to 4 compare photographs of fat flakes and pepperoni comprising said fat flakes according to the invention with comparative fat flakes and pepperoni comprising said comparative fat.

FIGS. 5 and 7 illustrate refrigerated pepperoni according to the invention.

FIG. 6 illustrates frozen pepperoni according to the invention.

### DETAILED DESCRIPTION OF THE INVENTION

The following examples are for illustrative purposes only, and are not intended to limit the scope of the invention in any way.

### Example 1: Content of Insoluble Fibers in Non-Animal Fibers

Various non-animal fibers were analyzed to determine the content by weight of the insoluble fibers. Results are shown in Table 1

TABLE 1

| Non-animal fibers | Total amount of insoluble fibers (%) |
|---|---|
| Citrus | 50.7% |
| Pea | 92.7% |
| Bamboo | 99.8% |
| Oat | 100.0% |
| Inulin | <0.2% |
| Acacia | 1.2% |

It can be seen that the inulin and acacia are considered as soluble non-animal fibers since the content of insoluble fibers is significantly low. In very clear contrast, citrus fibers, pea fibers, bamboo fibers and oat fibers are considered as insoluble non-animal fibers.

### Example 2: Process for Preparation of Plant-Based Pepperoni

Fat flakes

Pepperonis were made from meat analogue compositions comprising Fat A to Fat D (i.e. meat analogue compositions according to the invention), and from meat analogue compositions comprising a comparative Fat E to comparative Fat G.

Fat A was prepared by mixing 80 wt. % of melted coconut fat and 20 wt. % of citrus fibers. Then, the mixture was poured onto an ambient plate and cooled until the fat composition was solidified. The fat composition was subsequently broken so as to obtain flakes.

Fat B was prepared by mixing 80 wt. % of melted coconut fat and 20 wt. % of pea fibers. Then, the mixture was poured onto an ambient plate and cooled until the fat composition solidified. The fat composition was subsequently broken so as to obtain flakes.

Fat C was prepared by mixing 90 wt. % of melted coconut fat and 10 wt. % of bamboo fibers.

Then, the mixture was poured onto an ambient plate and cooled until the fat composition solidified. The fat composition was subsequently broken so as to obtain flakes.

Fat D was prepared by mixing 85 wt. % of melted coconut fat and 15 wt. % of oat fibers. Then, the mixture was poured onto an ambient plate and cooled until the fat composition solidified. The fat composition was subsequently broken so as to obtain flakes.

Fat E was prepared by mixing 80 wt. % of melted coconut fat and 20 wt. % of inulin fibers. Then, the mixture was poured onto an ambient plate and cooled until the fat composition solidified. The fat composition was subsequently broken so as to obtain flakes.

Fat F was prepared by mixing 80 wt. % of melted coconut fat and 20 wt. % of acacia fibers. Then, the mixture was poured onto an ambient plate and cooled until the fat composition solidified. The fat composition was subsequently broken so as to obtain flakes.

Comparative Fat G was prepared by melting 100 wt % of coconut fat. Then, the melted coconut oil was then crystalized onto a chilled drum to form flakes.

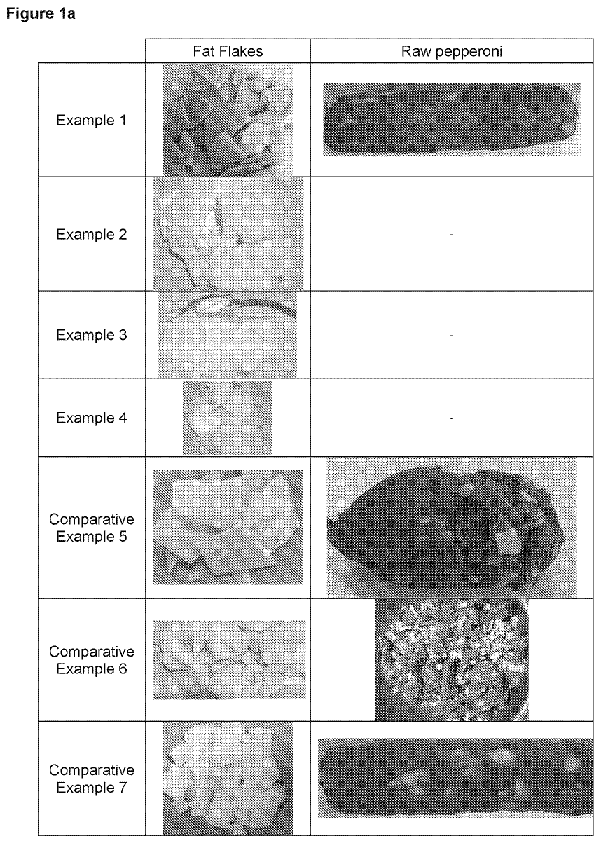

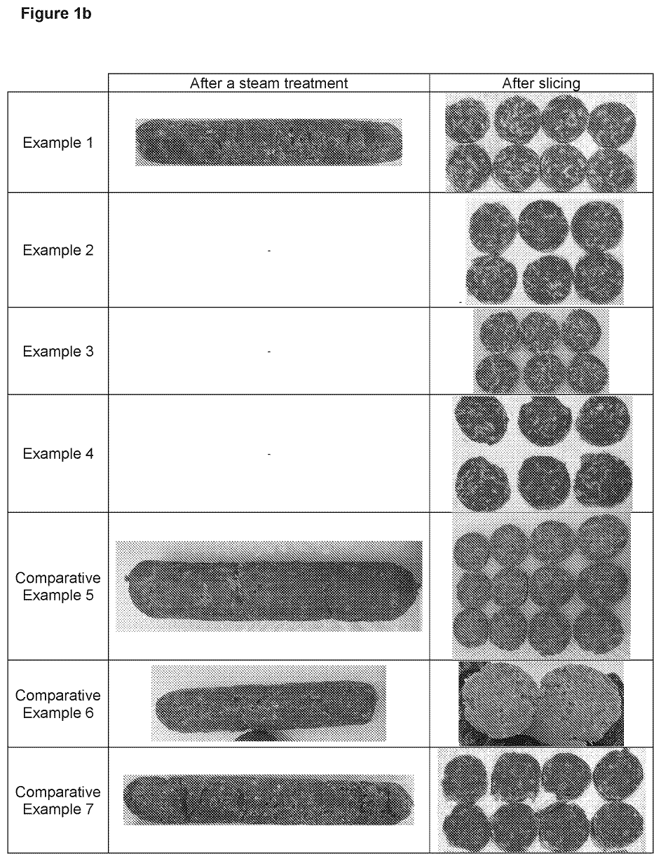

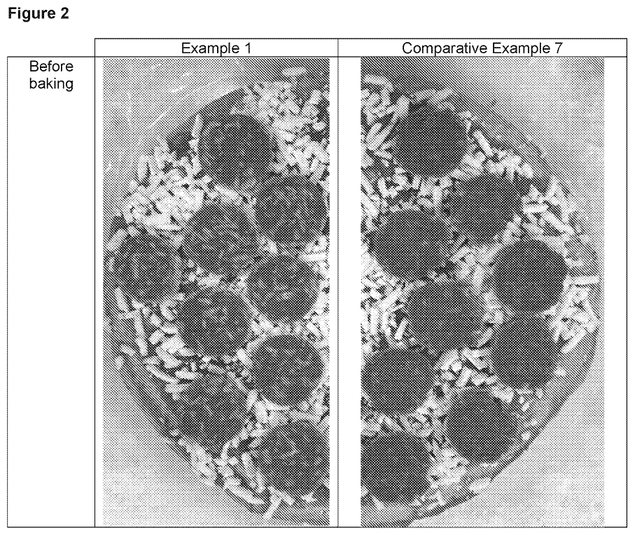

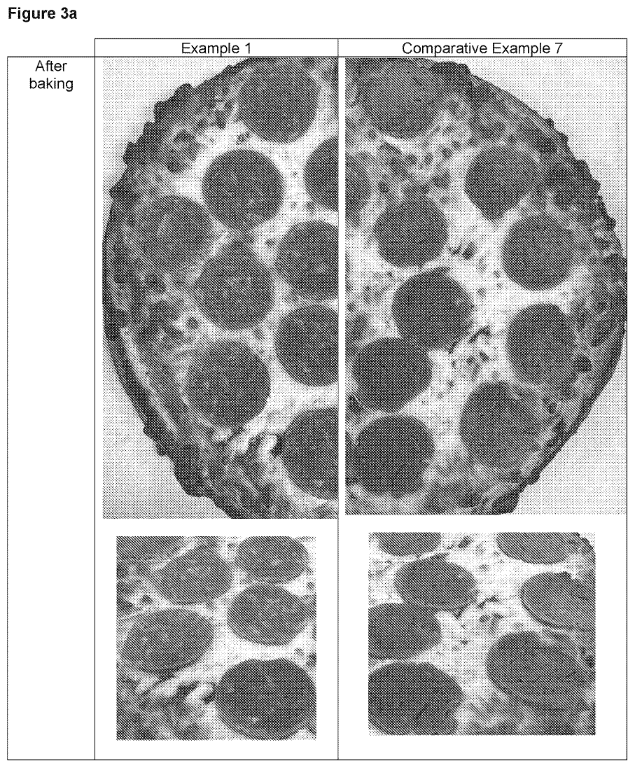

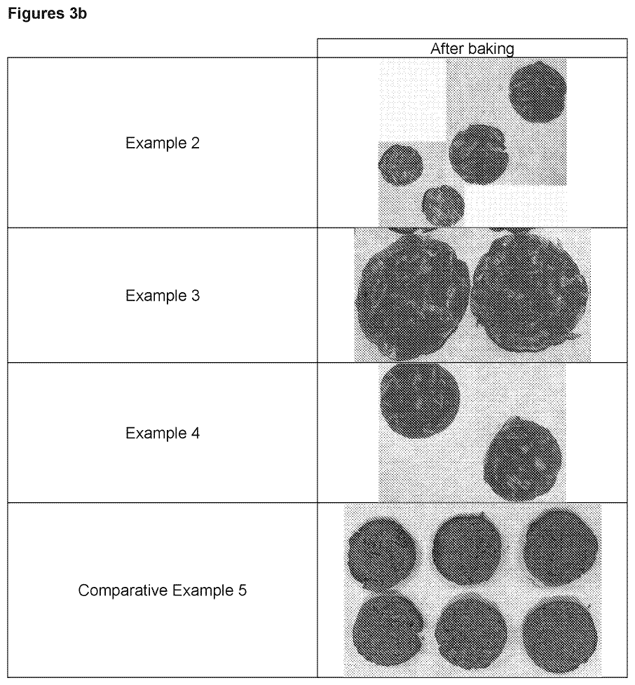

The process for the preparation of the plant-based pepperonis used comprised the steps of:
A). Providing a mixture of providing a mixture of a non-animal protein and water;
wherein
   A non-animal protein; all other ingredients in powder form including additives, flavours, colouring additives, were mixed and hydrated with water by blending for around 4 minutes;
B). Combining the mixture from step A) with the fat composition in solid form and optionally one or more additional components to form the meat analogue composition, wherein:
   The mixture from step A) and any further ingredients in molten form (e.g. flavours, additives in molten form) were combined and mixed for about 30 seconds;
   The obtained mixture was mixed with fat flakes A or comparative fat flakes B and mixed for about 1 minute;
C). Forming the meat analogue composition into food products, wherein:
   A jerkey gun was used on the mixture of step 3) to obtain a dough of raw pepperoni surrounded by a fiber casing as illustrated in FIG. 1;
   A steam treatment was then realized at 85° C. during 20 minutes;
   The steamed peperoni was then rested in a fridge for at least 12 hours before being sliced (FIG. 1);
   The sliced pepperoni was disposed onto a pizza (FIG. 2); and
   Samples were baked at 218° C. in an oven during 12-14 minutes (FIG. 3).

The compositions of the plant-based pepperonis are shown in Table 2.

TABLE 2

| | | | | | Comparative | Comparative | Comparative |
|---|---|---|---|---|---|---|---|
| | Example 1 | Example 2 | Example 3 | Example 4 | Example 5 | Example 6 | Example 7 |
| Ingredients | (wt %) | (wt %) | (wt %) | (wt %) | (wt %) | (wt %) | (wt %) |
| Non-animal protein | 19.7% | 18.8% | 18.8% | 18.8% | 18.8% | 18.8% | 19.7% |
| Flavours | 1.1% | 1.1% | 1.1% | 1.1% | 1.1% | 1.1% | 1.1% |
| Colouring additives | 0.5% | 0.4% | 0.4% | 0.4% | 0.4% | 0.4% | 0.5% |
| Water | 37.8% | 36.2% | 36.2% | 36.2% | 36.2% | 36.2% | 37.8% |
| Additives | 20.9% | 24.3% | 24.3% | 24.3% | 24.3% | 24.3% | 20.9% |
| Fat Flakes | Fat A: 20% | Fat B: 19.1% | Fat C: 19.1% | Fat D: 19.1% | Fat E: 19.1% | Fat F: 19.1% | Comparative |
| | | | | | | | fat G: 20% |

As illustrated in FIGS. 1a and 1b, after the steam treatment, comparative Examples 5 to 7 have a significant amount of holes formed during the steam treatment when compared to Examples 1 to 4. Furthermore, the sliceability of Examples 1 to 4 is significantly improved since the sliced pepperonis have a consistent and uniform shape whereas the comparative Examples 5 to 7 have fallen a little bit apart during the slicing. Accordingly, Examples 1 to 4 provide a solution that is as good with regard to hardness as the currently preferred state of the art for meat analogue compositions. Additionally, the visual marbling aspect of Examples 1 to 4 is clearly improved after the steam treatment when compared to the comparative Examples 5 to 7 as illustrated in FIGS. 1a and 1b and 2.

FIGS. 3a and 3b also show that thanks to the presence of Fat A to Fat D, the visual marbling aspect of Examples 1 to 4 is maintained after a baking step whereas almost all the Comparative Fat E and G of the Comparative Examples 5 and 7 have been removed in the meat product leaving several holes.

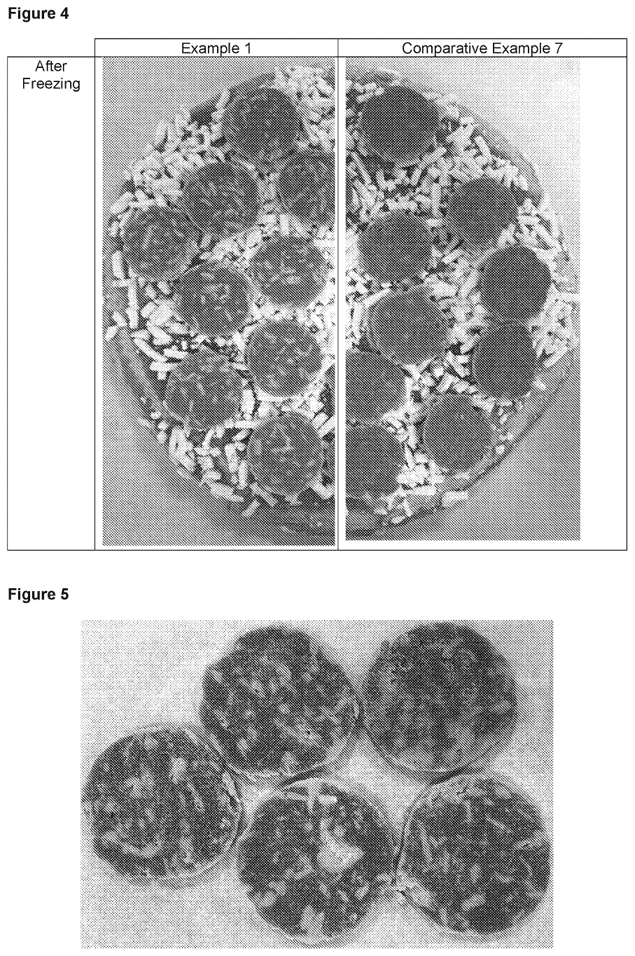

FIG. 4 illustrates an example wherein Example 1 and Comparatives Example 2 have been frozen during 4 hours. Example 1 again maintains a good visual marbling aspect of Example 1 when compared to the comparative Example 2.

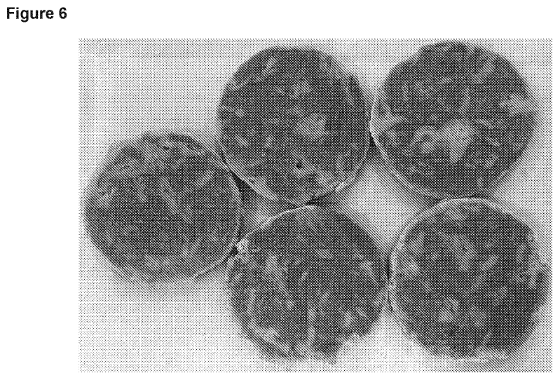

FIG. 5 illustrates an example wherein Example 1 has been refrigerated during 3 month and FIG. 6 illustrates an example wherein Example 1 has been frozen during 3 month. Example 1 shows an improved behaviour with respect to the shelf stability.

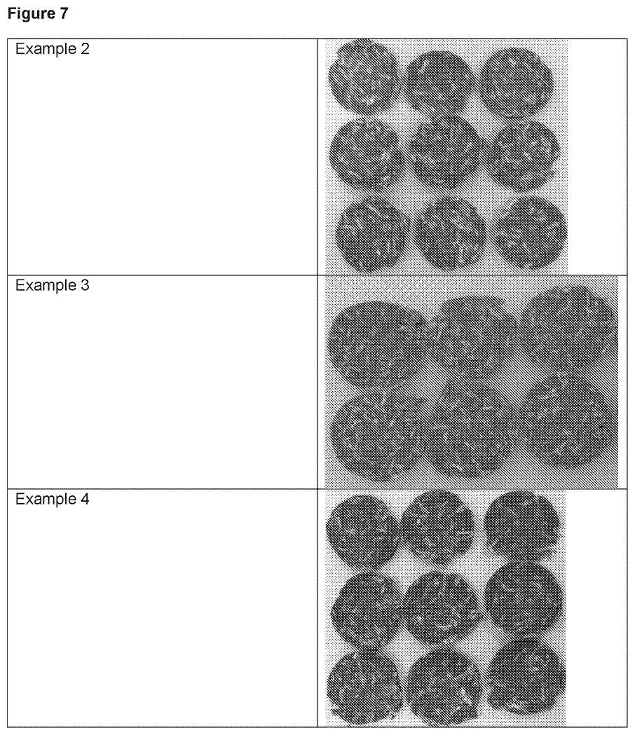

FIG. 7 illustrates an example wherein Examples 2 to 4 have been conserved in a cold storage; 6 weeks for Examples 2 and 4, and 5 weeks for Example 3. Examples 2 to 4 show a good shelf stability.
Fat granulates

Pepperonis were made from meat analogue compositions comprising Fat A (i.e. a meat analogue composition according to the invention), and from meat analogue compositions comprising a Comparative Fat G (i.e. a meat analogue composition comprising coconut fat).

Fat A′ was prepared by mixing 80 wt. % of melted coconut fat and 20 wt. % of citrus fibers.

Then, the mixture was poured onto an ambient plate and cooled until the fat composition was solidified. The fat composition was subsequently broken so as to obtain flakes. Flakes were diced to obtain granulates.

Comparative Fat G′ was prepared by melting 100 wt % of coconut fat. Then, the melted coconut oil was crystalized onto a chilled drum to form flakes. Flakes were grinded so as to obtain granulates.

Fat A′ and Comparative Fat G′ were essentially identical to Fat A and Comparative Fat G discussed above. The pepperonis according to the invention contained visible fat flakes or granulates and had a good visual marbling aspect even after processing, i.e. a heat treatment and a cooking step, the pepperoni analogue composition when compared to pepperonis prepared containing just coconut fat. The visible fat flakes or granulates resembled the look and feel of animal meat. The pepperonis containing only coconut fat did not contain visible fat structures leaving several holes, less resembling the look and feel of animal meat. The pepperonis according to the invention had also a positive effect on texture relating features. Finally, the pepperonis according to the invention had good shelf stability.

1. A meat analogue composition comprising a fat composition in solid form, wherein the fat composition comprises a vegetable fat and non-animal insoluble fibers, said vegetable fat and non-animal insoluble fibers being intermixed.

2. The meat analogue composition according to claim 1, wherein the non-animal insoluble fibers are selected from vegetable fibers, fruit fibers, plant fibers and any combination thereof.

3. The meat analogue composition according to claim 1, wherein the non-animal insoluble fibers are selected from citrus fibers, peas fibers, potato fibers, bamboo fibers, oat fibers, wheat fibers, cellulose fibers, and any combination thereof.

4. The meat analogue composition according to claim 1, wherein the non-animal insoluble fibers comprise less than 30% by weight of protein.

5. The meat analogue composition according to claim 1, wherein only the vegetable fat and non-animal insoluble fibers are intermixed together.

6. The meat analogue composition according to claim 1, wherein the fat composition comprises from 5 to 35% by weight of non-animal insoluble fibers and from 65 to 95% by weight of the vegetable fat.

7. The meat analogue composition according to claim 1, wherein the fat composition comprises from 10 to 30% by weight of non-animal insoluble fibers and from 70 to 90% by weight of the vegetable fat.

8. The meat analogue composition according to claim 1, wherein the vegetable fat is selected from palm fat, coconut fat, rapeseed fat, high oleic rapeseed fat, high erucic acid rapeseed fat, soybean fat, sunflower fat, high oleic sunflower fat, linseed fat, olive fat, corn fat, cottonseed fat, carinata fat, groundnut fat, safflower fat, shea butter, cocoa butter, allanblackia fat, kokum fat, mango kernel fat, sal fat, illipe butter, palm kernel olein, babassu fat, high oleic safflower fat, peanut fat, avocado fat, rice fat, camelina fat, any fractions thereof and any combination thereof.

9. The meat analogue composition according to claim 1, wherein the vegetable fat comprises an interesterified fat.

10. The meat analogue composition according to claim 1, wherein the vegetable fat comprises an interesterified blend of shea butter and coconut oil or an interesterified blend of shea stearin and coconut oil.

11. The meat analogue composition according to claim 1, wherein the vegetable fat comprises an interesterified blend of from 20% to 80% by weight of shea butter and from 20% to 80% by weight of coconut oil.

12. The meat analogue composition according to claim 1, wherein the vegetable fat comprises an interesterified blend of from 20% to 80% by weight of shea stearin and from 20% to 80% by weight of coconut oil.

13. The meat analogue composition according to claim 1, wherein the vegetable fat comprises a fully hydrogenated fat.

14. The meat analogue composition according to claim 1, wherein the vegetable fat comprises a hydrogenated blend of soybean fat and coconut fat.

15. The meat analogue composition according to claim 1, wherein the vegetable fat comprises a hydrogenated blend of from 1% to 30% by weight of soybean fat and from 70% to 99% by weight of coconut oil.

16. The meat analogue composition according to claim 1, wherein the vegetable fat comprises a hydrogenated blend of rapeseed fat and coconut fat.

17. The meat analogue composition according to claim 1, wherein the vegetable fat comprises a hydrogenated blend of from 1% to 30% by weight of rapeseed fat and from 70% to 99% by weight of coconut oil.

18. The meat analogue composition according to claim 1, wherein the vegetable fat comprises a hydrogenated blend of sunflower fat and coconut fat.

19. The meat analogue composition according to claim 1, wherein the vegetable fat comprises a hydrogenated blend of from 1% to 30% by weight of sunflower fat and from 70% to 99% by weight of coconut oil.

20. The meat analogue composition according to claim 1, wherein the fat composition is in the form of discrete fat pieces in the meat analogue composition.

21. The meat analogue composition according to claim 1, wherein the fat composition is in the form of granulates and/or flakes.

22. The meat analogue composition according to claim 21, wherein the granulates have a particle size distribution between 1 mm and 7 mm.

23. The meat analogue composition according to claim 21, wherein the flakes have a thickness between 0.2 mm and 1.5 mm.

24. The meat analogue composition according to claim 23, wherein the flakes have a thickness between 0.3 mm and 0.9 mm.

25. The meat analogue composition according to claim 23, wherein the flakes have a thickness between 0.9 mm and 1.3 mm.

26. The meat analogue composition according to claim 21, wherein the flakes have a diameter between 1 and 52 mm.

27-36. (canceled)

37. The meat analogue composition according to claim 1, wherein the meat analogue composition comprises a non-animal protein and water.

38-41. (canceled)

42. The meat analogue composition according to claim 37, wherein the non-animal protein is present in the meat analogue composition in an amount of from 5 to 30% by weight of the meat analogue composition.

43. (canceled)

44. The meat analogue composition according to claim 37, wherein water is present in the meat analogue composition in an amount of from 20 to 70% by weight of the meat analogue composition.

45-49. (canceled)

50. The meat analogue composition according to claim 1, wherein the fat composition is present in the meat analogue composition in an amount of from 5% to 40% by weight of the meat analogue composition.

51. (canceled)

52. The meat analogue composition according to claim 1, wherein the meat analogue composition is free of palm and palm kernel oils.

53. The meat analogue composition according to claim 1, wherein the meat analogue composition is free of hydrogenated oils.

54. The meat analogue composition according to claim 1, wherein the meat analogue composition is substantially free of animal protein and/or animal fats.

55. The meat analogue composition according to claim 1, wherein the meat analogue composition is substantially free of animal-derived products.

56. The meat analogue composition according to claim 1, wherein the meat analogue composition is substantially free of emulsions.

57. The meat analogue composition according to claim 1, wherein the meat analogue composition is not in a form of an emulsion.

58. A food product comprising a meat analogue composition according to claim 1.

59-84. (canceled)

85. A process of manufacturing a meat analogue composition according to claim 1, wherein the process comprises:
A). providing a mixture comprising a non-animal protein and water;
B). combining the mixture from step A) with the fat composition in solid form and optionally one or more additional components to form the meat analogue composition; and
C). optionally forming the meat analogue composition into food products.

86-98. (canceled)
